(19) United States
(12) Patent Application Publication
(10) Pub. No.: US 2012/0098222 A1
(43) Pub. Date: Apr. 26, 2012

(54) CASTER SWITCHING MECHANISM FOR SCOOTER AND METHOD OF OPERATING THE SAME

(75) Inventor: Kun-Do CHAN, Tainan City (TW)

(73) Assignee: J.D. COMPONENTS CO., LTD., Shou Shui Hsiang (TW)

(21) Appl. No.: 12/952,117

(22) Filed: Nov. 22, 2010

(30) Foreign Application Priority Data
Oct. 26, 2010 (TW) 99136531

(51) Int. Cl. B62M 1/00

(52) U.S. Cl. 280/87.041

(57) ABSTRACT

A caster switching mechanism for installation in a footboard of a scooter is used to control, through a switch pivotally connected with the footboard, whether a wheel seat is rotatable relative to footboard. When the switch is located at a restricted position where the wheel seat is stopped by the switch, the wheel seat is prohibited from rotation relative to the footboard such that a wheel that is rotatably mounted to the wheel seat can roll along one direction only. When the switch is located at an unrestricted position where the switch is separated from the wheel seat, the wheel seat is rotatable relative to the footboard such that the wheel can roll along any direction corresponding to the orientation of the wheel seat.

### BACKGROUND OF THE INVENTION

1. Field of the Invention

The present invention relates generally to a scooter, and more specifically to a caster switching mechanism for a scooter, which enables a wheel of the caster assembly to roll in one direction or in any direction selectively.

2. Description of the Related Art

Conventional scooters, which are commonly used as sports equipments, can be mainly classified into two types based on the construction thereof. One is equipped with a rigid caster having a wheel seat stationarily fastened to the bottom of a footboard of the scooter such that the wheel that is rotatably connected with the wheel seat can roll in one direction only. Under this circumstance, a user standing on the footboard needs to kick the ground with one foot to propel the scooter forward. The disadvantage of the scooter of this type lies in that the user will need a well-trained skill to manipulate the scooter especially in the process of changing the scooter's direction because the scooter is not easy to change its direction when the wheel is traveling along a fixed direction. On the other hand, the other type is equipped with a swivel caster having a wheel seat rotatably mounted to the bottom of the footboard of the scooter, such that the wheel of the swivel caster can roll in any direction. To propel the scooter of this type and to manipulate the heading direction of the scooter, the user standing on the footboard can twist his body in cooperation with the rotation of the wheel seat.

For many scooter fans, they usually learn how to play the first-type scooter at first, and then the second-type scooter after they develop their skills. However, there are no commercially available scooters adopting dual modes, i.e. a rigid caster mode and a swivel caster mode, at present. This means that the fans will need to spend more money on different types of the scooters for satisfying their learning and playing.

### SUMMARY OF THE INVENTION

It is one objective of the present invention to provide a caster switching mechanism for a scooter, which can control whether or not a wheel seat is rotatable relative to a footboard of the scooter to satisfy different needs.

To achieve this objective of the present invention, the caster switching mechanism provided by the present invention comprises a caster assembly and a switch. The caster assembly has a wheel seat with a top end adapted for being rotatably connected with a bottom of a footboard of a caster, and a wheel rotatably connected with a bottom end of the wheel seat. The switch is adapted for being movably connected with the footboard of the scooter in such a way that the switch is movable relative to the footboard of the scooter between a restricted position where a first restricting portion of the wheel seat is stopped by a second restricting portion of the switch such that the wheel seat is prohibited from rotation relative to the footboard of the scooter, and an unrestricted position where the first restricting portion of the wheel seat and the second restricting portion of the switch are separated from each other for allowing the wheel seat to be rotatable relative to the footboard of the scooter.

Preferably, the first restricting portion of the restricting member is formed by two opposite planes, and the second restricting portion of the switch is formed by two spaced lateral walls. When the switch is located at the restricted position, the lateral walls of the switch are abutted against the planes of the restricting member, and when the switch is located at the unrestricted position, the lateral walls of the switch and the planes of the restricting member are separated from each other.

Preferably, a treadle can be mounted with one end of the switch and driven by an external force to move the switch.

Preferably, an elastic member can be disposed between the footboard of the scooter and the switch for elastically urging the switch by means of providing a rebound force to the switch.

To achieve the aforesaid objective of the present invention, a method of operating the caster switching mechanism provided by the present invention comprises the steps of a) stepping on the switch to drive the switch to move from the restricted position to the unrestricted position for enabling the wheel seat to be rotatable relative to the footboard of the scooter, and b) releasing the switch to allow the switch to move from the unrestricted position back to the restricted position for prohibiting the wheel seat from rotation relative to the footboard of the scooter.

To achieve the aforesaid objective of the present invention, another method of operating the caster switching mechanism provided by the present invention comprises the steps of a) stepping on the switch to drive the switch to move from the unrestricted position to the restricted position for prohibiting the wheel seat from rotation relative to the footboard of the scooter, and b) releasing the switch to allow the switch to move from the restricted position back to the unrestricted position for enabling the wheel seat to be rotatable relative to the footboard of the scooter.

Preferably, the wheel seat is adapted for being pivotally connected with a bevel plate of the footboard of the scooter and the wheel rolls along a direction parallel to a horizontal direction of an inclined surface of the bevel plate when the switch is located at the restricted position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a scooter in which a caster switching mechanism according to a first embodiment of the prevent invention is installed;

FIG. 2 is an enlarged view of a part of the scooter of FIG. 1, showing that the switch is rested at a restricted position where no external force is exerted on the treadle;

FIG. 3 is an exploded view of a part of the scooter including the caster switching mechanism according to the first embodiment of the prevent invention;

FIG. 4 is a sectional view of a part of the scooter including the caster switching mechanism according to the first embodiment of the prevent invention, showing that the switch is located at the restricted position;

FIG. 5 is similar to FIG. 2, but showing that the switch is stayed at an unrestricted position where the treadle receives thereon an external force;

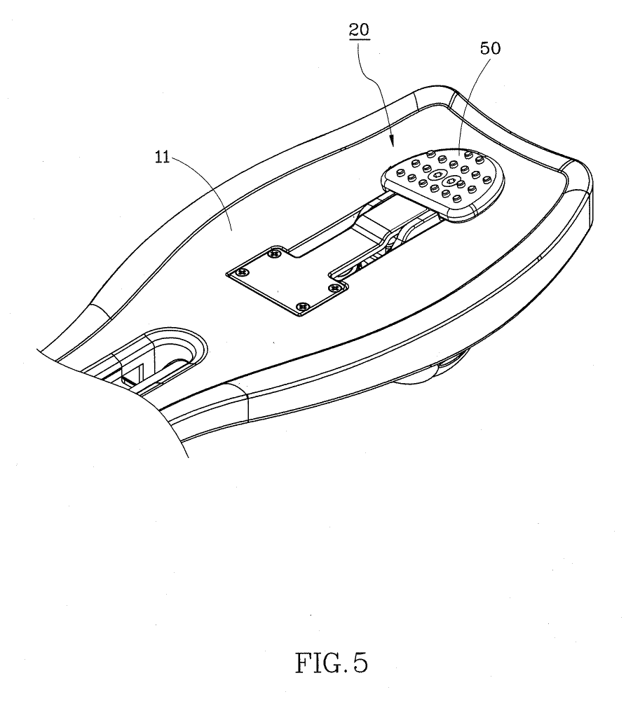

FIG. 6 is similar to FIG. 4, but that showing the switch is located at the unrestricted position;

FIG. 7 is a sectional view of a part of a scooter including a caster switching mechanism according to a second embodiment of the prevent invention, showing that the switch is located at the unrestricted position; and

FIG. 8 is similar to FIG. 7, but showing that the switch is located at the restricted position.

### DETAILED DESCRIPTION OF THE INVENTION

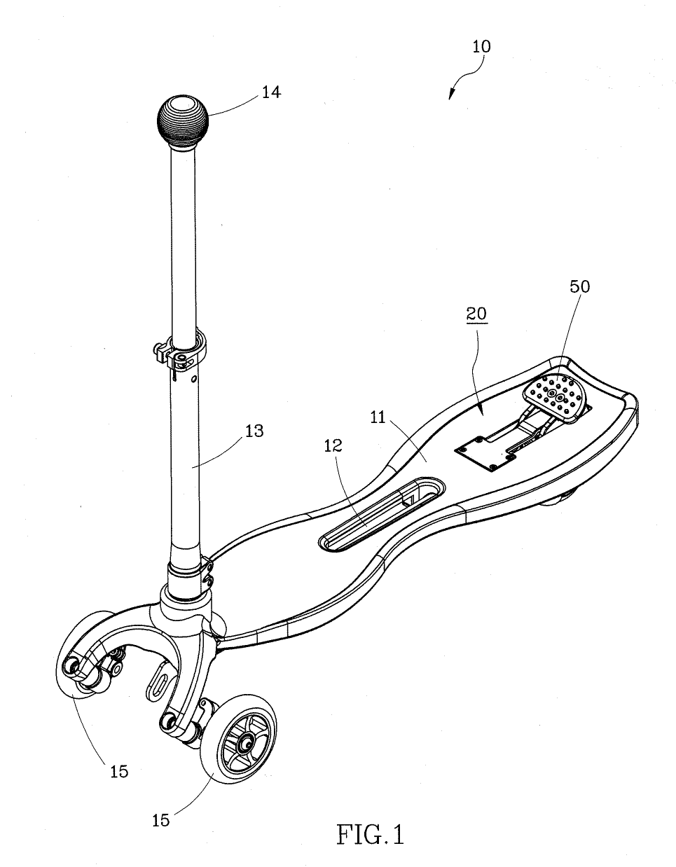

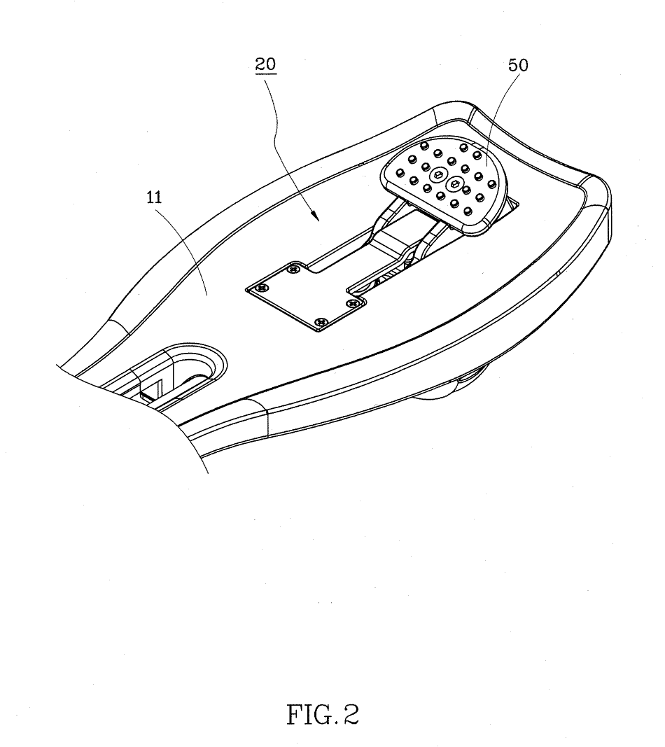

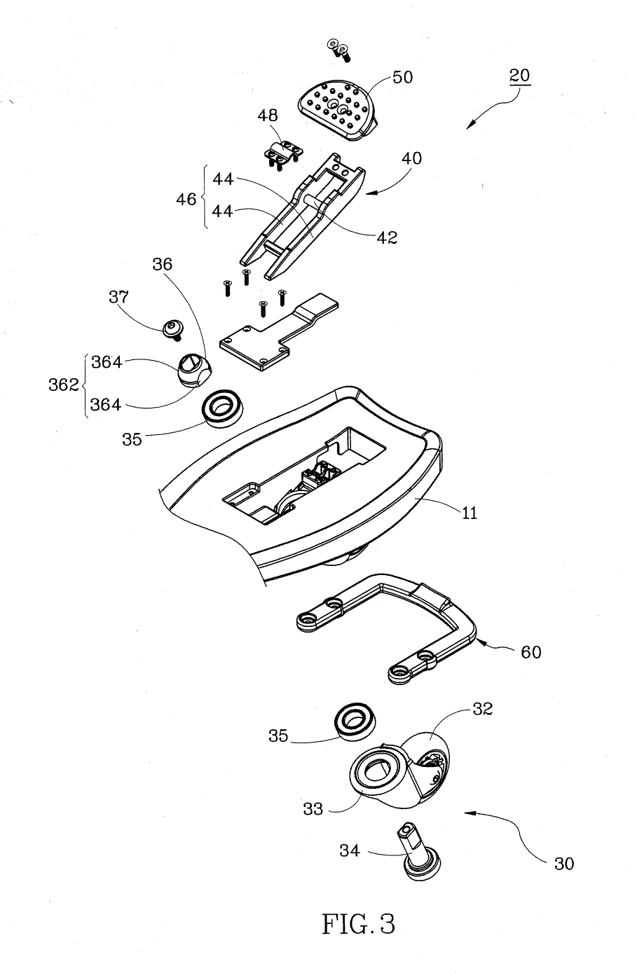

As shown in FIGS. 1 and 2, a caster switching mechanism 20 in accordance with a first embodiment of the present invention is adapted to be installed in a scooter 10. In this embodiment, the scooter 10 includes a footboard 11 on which a user is standable, a rotating shaft 12 installed in the footboard 11, a front tube 13 connected upright with a front end of the footboard 11, a handlebar 14 connected with a top end of the front tube 13, and two front wheels 15 rotatably connected with the front end of the footboard 11. As shown in FIGS. 2 and 3, the caster switching mechanism 20 comprises a caster assembly 30, a switch 40, a treadle 50, and an elastic member 60.

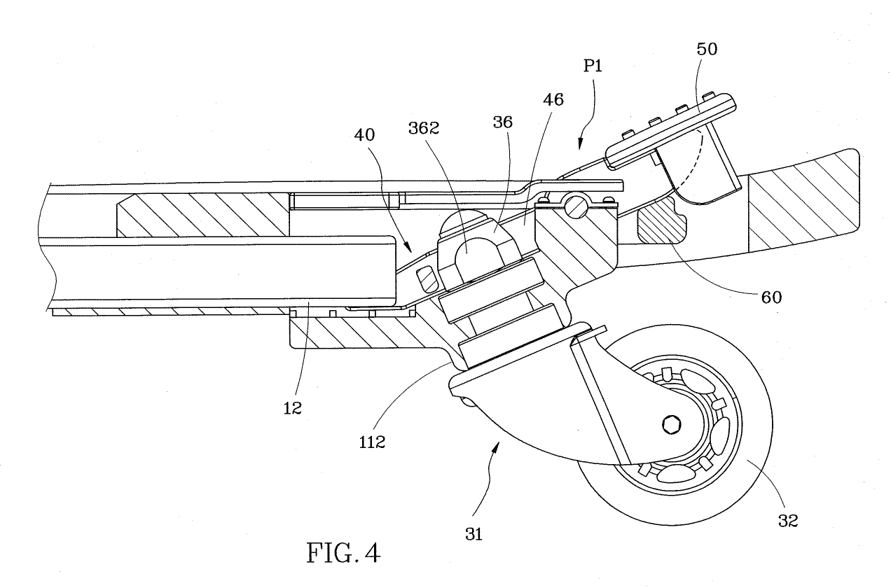

As shown in FIGS. 3 and 4, the caster assembly 30 includes a wheel seat 31 and a wheel 32. The wheel seat 31 has a seat body 33 with a bottom end connected with the wheel 32, a pivot 34 passing through the seat body 33 and a bevel plate 112 of the footboard 11 and fastened with a screw 37 such that the wheel seat 31 is installed in an inclined manner, two bearings 35 sleeved on the pivot 34, and a restricting member 36 sleeved on the pivot 34 and provided with a first restricting portion 362 formed by two opposite planes 364.

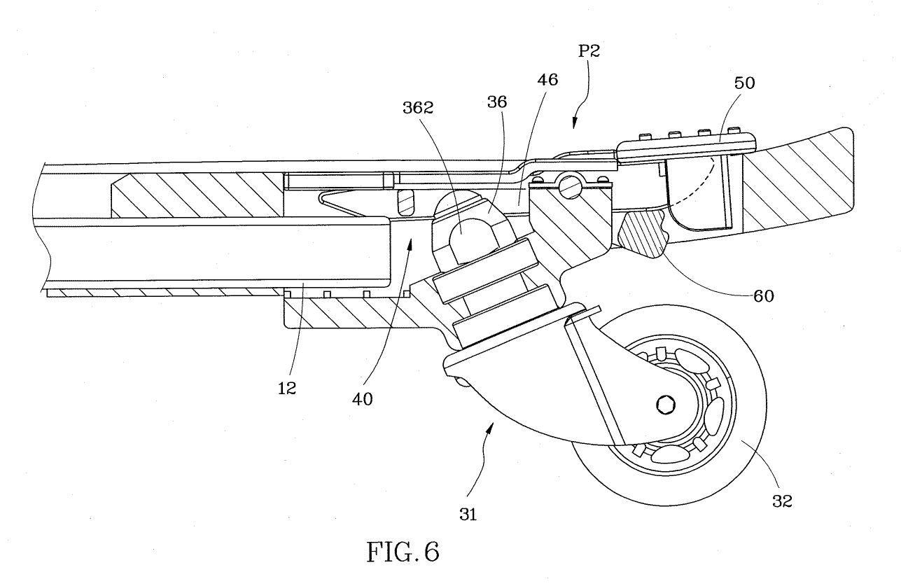

The switch 40 has two spaced lateral walls 44 forming a second restricting portion 46 for accommodation of the restricting member 36 of the wheel seat 31 therebetween, and a pivot 42 connected between the lateral walls 44 and located at about the middles of the lateral walls 44 and pivotally fastened to a rear end of the footboard 11 through a locking plate 48. By this way, the switch 40 can be pivotable around the pivot 44 relative to the footboard 11 between a restricted position P1 where the middle of the second restricting portion 46 of the switch 40 is abutted against the first restricting portion 362 of the restricting member 36 and the front end of the second restricting portion 46 of the switch 40 is abutted against two opposite sides of the rotating shaft 12, as shown in FIG. 4, such that the wheel seat 31 is prohibited from rotation relative to the footboard 11, and an unrestricted position P2 where the second restricting portion 46 of the switch 40 is simultaneously separated from the first restricting portion 362 of the restricting member 36 and the opposite sides of the rotating shaft 12, as shown in FIG. 6, such that the wheel seat 31 is rotatable relative to the footboard 11.

The treadle 50 is fastened to the rear end of the switch 40, and drivenable by an external force generated from the user's stepping on the treadle 50 to move the switch 40 from the restricted position P1, as shown in FIG. 4, to the unrestricted position P2, as shown in FIG. 6.

The elastic member 60, which is embodied as a U-shaped spring, is fastened to the footboard 11 in such a way that the elastic member 60 is located between the footboard 11 and the switch 40, as shown in FIGS. 4 and 6, and elastically stopped against the switch 40 for providing a rebound force to the switch 40.

The structure of the caster switching mechanism 20 is described as above, and the method of operating the caster switching mechanism 20 of the invention will be more fully understood from the following description of the invention. The operation method includes the steps as follows.

a) Apply a force on the treadle 50 with the foot when a user stands on the footboard 11; therefore, the switch 40 can be driven to pivotally move from the restricted position P1, as shown in FIG. 4, to the unrestricted position P2, as shown in FIG. 6. Under this circumstance, the wheel seat 31 can be rotatable relative to the footboard 11, and therefore the scooter 10 can be steered easily when the user twists his body in cooperation with the rotation of the wheel seat 31. In other words, the caster assembly 30 is at this condition served as a swivel caster assembly where the wheel 32 can roll in any direction corresponding to the orientation of the wheel seat 31.

b) Thereafter, the user can remove the foot from the treadle 50 to release the force applied on the treadle 50, such that the switch 40 will be pivotally moved by the help of the elastic member 60 from the unrestricted position P2 back to the restricted position P1 where the wheel seat 31 is prohibited from rotation relative to the footboard 11. Accordingly, the caster assembly 30 is at this condition served as a rigid caster assembly where the wheel 32 can roll along only one direction that is parallel to the horizontal direction of an inclined surface of the bevel plate 112 of the footboard 11. As a result, the user can kick the ground with one foot to move the scooter 10 forward.

By means of the aforesaid design, the switch can be driven to pivotally move by treading on the treadle for determining whether the wheel seat is able to rotate relative to the footboard or not, such that the user can choose the mode of operating the scooter according to the user's needs, and furthermore the user doesn't need to spend money to buy different types of scooters when getting promoted in operating skills. Thus, the scooter 10 equipped with the caster switching mechanism 20 of the present invention has the advantage of adding interest to the user and saving the user's cost.

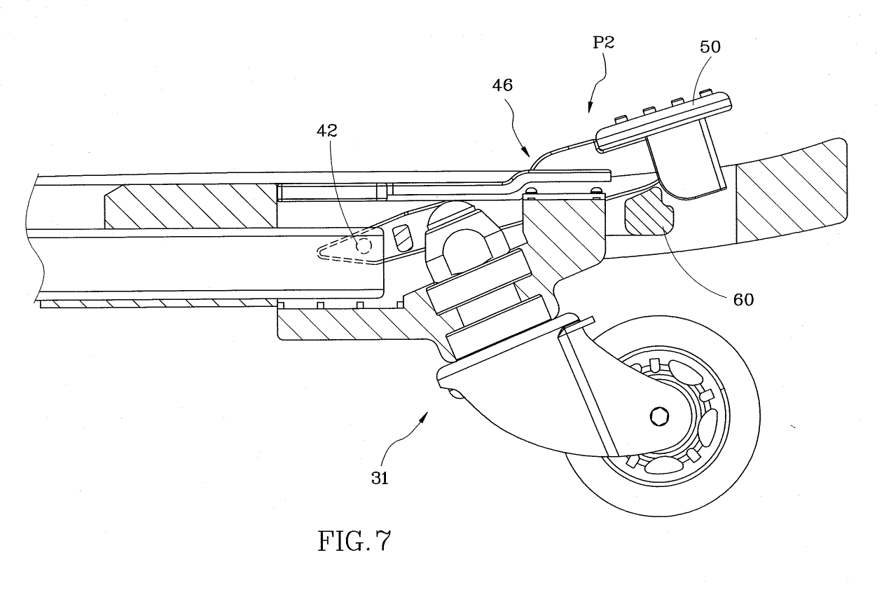

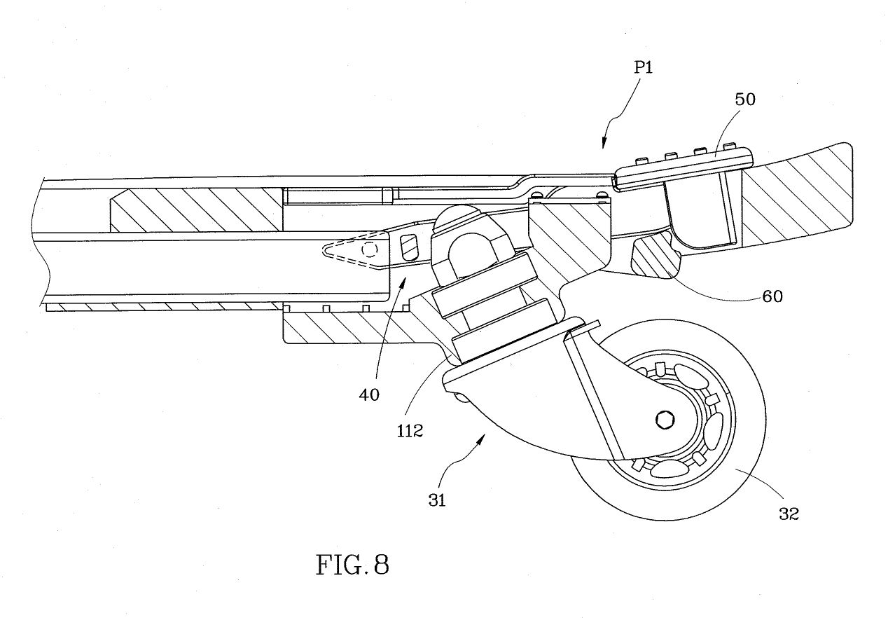

It is to be mentioned that the pivot 42 of the switch 40 isn't limited to be connected with the middles of the lateral walls 44, and can be designed to be connected with the front ends of the lateral walls 44, such that the switch 40 is pivotally moved from the unrestricted position P2, as shown in FIG. 7, to the restricted position P1, as shown in FIG. 8, when the user steps on the treadle 50. Under this circumstance, the method of operating the caster switching mechanism 20 of the invention includes the steps as follows.

a) Apply a force on the treadle 50 with the foot when the user stands on the footboard 11; therefore, the switch 40 can be driven to pivotally move from the unrestricted position P2, as shown in FIG. 7, to the restricted position P1, as shown in FIG. 8. At this time, the wheel seat 31 is prohibited from rotation relative to the footboard 11, and the wheel 32 can roll along only one direction that is parallel to the horizontal direction of an inclined surface of the bevel plate 112 of the footboard 11. Under this circumstance, the user needs to kick the ground with one foot to move the scooter 10 forward.

b) Thereafter, the user can remove the foot from the treadle 50 to release the force applied on the treadle 50, such that the switch 40 will be pivotally moved by the help of the elastic member 60 from the restricted position P1, as shown in FIG. 8, back to the unrestricted position P2, as shown in FIG. 7, for enabling the wheel seat 31 to be rotatable relative to the footboard 11. Under this circumstance, the user can twist his body to steer the scooter 10 easily through the cooperation of the rotation of the wheel seat 31.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A caster switching mechanism for a scooter having a footboard on which a user is standable, the caster switching mechanism comprising:
a caster assembly having a wheel seat provided with a top end for being rotatably connected with a bottom of the footboard of the scooter and a first restricting portion, and a wheel rotatably connected with a bottom end of the wheel seat, and
a switch for being movably connected with the footboard of the scooter in a way that the switch is movable relative to the footboard of the scooter between a restricted position where the first restricting portion of the wheel seat is stopped by a second restricting portion of the switch such that the wheel seat is prohibited from rotation relative to the footboard of the scooter, and an unrestricted position where the first restricting portion of the wheel seat and the second restricting portion of the switch are separated from each other such that the wheel seat is rotatable relative to the footboard of the scooter.

2. The caster switching mechanism as claimed in claim 1, wherein the wheel seat has a restricting member with the first restricting portion.

3. The caster switching mechanism as claimed in claim 2, wherein the first restricting portion of the restricting member is formed by two opposite planes, and the second restricting portion of the switch is formed by two spaced lateral walls; the lateral walls of the switch are abutted against the planes of the restricting member when the switch is located at the restricted position, and separated from the planes of the restricting member when the switch is located at the unrestricted position.

4. The caster switching mechanism as claimed in claim 3, wherein the switch is configured for being pivotally connected with the footboard of the scooter through a pivot connected between the lateral walls of the switch.

5. The caster switching mechanism as claimed in claim 3, wherein the second restricting portion of the switch is engaged with two opposite sides of a rotating shaft installed in the footboard of the scooter when the switch is located at the restricted position, and disengaged from the opposite sides of the rotating shaft when the switch is located at the unrestricted position.

6. The caster switching mechanism as claimed in claim 1, further comprising a treadle mounted with one end of the switch to be driven by an external force to move the switch from the restricted position to the unrestricted position.

7. The caster switching mechanism as claimed in claim 6, further comprising an elastic member disposed between the footboard of the scooter and the switch for elastically urging the switch to keep the switch at the restricted position.

8. The caster switching mechanism as claimed in claim 1, further comprising a treadle mounted with the switch to be driven by an external force to move the switch from the unrestricted position to the restricted position.

9. The caster switching mechanism as claimed in claim 8, further comprising an elastic member disposed between the footboard of the scooter and the switch for elastically urging the switch to keep the switch at the unrestricted position.

10. The caster switching mechanism as claimed in claim 7, wherein the elastic member is a U-shaped spring.

11. The caster switching mechanism as claimed in claim 9, wherein the elastic member is a U-shaped spring.

12. The caster switching mechanism as claimed in claim 1, wherein the wheel seat has a pivot for passing through a bevel plate of the footboard of the scooter such that the wheel seat is installed in an inclined manner.

13. The caster switching mechanism as claimed in claim 12, wherein the wheel rolls along a direction parallel to a horizontal direction of an inclined surface of the bevel plate when the switch is located at the restricted position.

14. The caster switching mechanism as claimed in claim 1, wherein the switch is configured for being pivotally connected with the footboard of the scooter.

15. A method of operating the caster switching mechanism as claimed in claim 1, comprising the steps of:
a) stepping on the switch to drive the switch to move from the restricted position to the unrestricted position for enabling the wheel seat to be rotatable relative to the footboard of the scooter; and
b) releasing the switch to allow the switch to move from the unrestricted position back to the restricted position for prohibiting the wheel seat from rotation relative to the footboard of the scooter.

16. The method as claimed in claim 15, wherein the wheel seat is configured for being pivotally connected with a bevel plate of the footboard of the scooter and the wheel rolls along a direction parallel to a horizontal direction of an inclined surface of the bevel plate when the switch is located at the restricted position.

17. A method of operating the caster switching mechanism as claimed in claim 1, comprising the steps of:
a) stepping on the switch to drive the switch to move from the unrestricted position to the restricted position for prohibiting the wheel seat from rotation relative to the footboard of the scooter; and
b) releasing the switch to allow the switch to move from the restricted position back to the unrestricted position for enabling the wheel seat to be rotatable relative to the footboard of the scooter.

18. The method as claimed in claim 17, wherein the wheel seat is configured for being pivotally connected with a bevel plate of the footboard of the scooter and the wheel rolls along a direction parallel to a horizontal direction of an inclined surface of the bevel plate when the switch is located at the restricted position.
